(19) United States
(12) Patent Application Publication
(10) Pub. No.: US 2008/0163553 A1
(43) Pub. Date: Jul. 10, 2008

(54) Control Device for Controlling Opening and Closing of a Window

(76) Inventor: YU-TSUN LIAO, Taichung city (TW)

Correspondence Address: Dr. BANGER SHIA, 102 Lindencrest Ct., Sugar Land, TX, 77479-5201, US

(21) Appl. No.: 11/621,322

(22) Filed: Jan. 9, 2007

(51) Int. Cl. E05F 15/00

(52) U.S. Cl. 49/362

(57) ABSTRACT

A control device for controlling opening and closing of a window comprises: a motor, a gear reduction mechanism and a supporting member with a rack. The motor and the gear reduction mechanism are fixed on the window. The rack and the supporting member are mounted to the window by mounting members. The motor serves to drive the gear reduction mechanism, and then the gear wheel of the gear reduction mechanism drives the rack and the supporting member to move, and consequently moves the window, thus providing a function of automatically opening and closing the window.

### BACKGROUND OF THE INVENTION

1. Field of the Invention

The present invention relates to a control device for controlling opening and closing of a window, and more particularly to a control device for controlling opening and closing of a window that is capable of opening and closing the window automatically.

2. Description of the Prior Art

Conventionally, a window can only be opened and closed manually, if the window is located at a relatively high position, it will be more difficult to open and close. And if it rains, it will be more inconvenient since the user has to close all the windows personally. In this a rapidly growing era of science and technology, it is necessary to develop a device that can open and close the window automatically. And therefore, the author of the invention has developed a control device for controlling opening and closing of a window.

### SUMMARY OF THE INVENTION

The primary objective of the present invention is to provide a control device for controlling opening and closing of a window capable of opening and closing the window automatically, wherein a motor is used to drive a gear reduction mechanism fixed on a window, and the gear wheel inside the gear reduction mechanism to drive the rack and the supporting member mounted on the window, thus driving the window to move.

The control device for controlling opening and closing of a window in accordance with the present invention comprises: a motor, a gear reduction mechanism and a supporting member. The gear reduction mechanism is fixed on the window (for example, fixed on the window frame, or on the wall). In the box of the gear reduction mechanism there are gear reduction subassemblies, including worm wheel, gear wheel, or compound gear set (such as planetary gear set), which provides a function of speed reduction. The gear reduction mechanism is exteriorly connected to the motor for driving the subassembly of the gear reduction mechanism, dynamic force is inputted in the input end of the motor and is transmitted to the output end of the gear reduction mechanism through the gear reduction subassembly. The output end of the gear reduction mechanism is engaged with a rack of the supporting member via a gear wheel. The rack and the supporting member are mounted to the window by mounting members. When the rack is driven to move, the supporting member integrally arranged with the rack will be caused to move the window, thus providing a function of automatically opening and closing the window.

In addition, to prevent the window from being damaged by hindrances or any other problems during the course of opening and closing, a safety device is arranged below the supporting member. The safety device includes a U-shaped frame for supporting the supporting member. An elastic piece is pushed against the bottom of the U-shaped frame. A plurality of screws is inserted through the bottom of the box In such a manner that the top end of the respective screws is inserted in the box and pushed against the bottom of the elastic piece, and thus the elastic piece is well positioned and supported. By such a design, the supporting member and the U-shaped frame can be positioned well by the upward pushing force of the wings of the elastic piece, or can move downward when subjected to a downward force. Therefore, in addition to being engaged with each other, the rack and the gear wheel can also be disengaged from each other when the movement of the window is hindered unexpectedly, thus providing a safety function, preventing the window from being damaged by hindrances or any other problems.

### BRIEF DESCRIPTION OF THE DRAWINGS

FIG. 1 is an illustrative view of showing that a control device for controlling opening and closing of a window in accordance with the present invention is mounted on a window;

FIG. 2 is an exploded view of the a control device for controlling opening and closing of a window in accordance with the present invention;

FIG. 3 is a perspective view of the a control device for controlling opening and closing of a window in accordance with the present invention;

FIG. 4 is an enlarged view of showing that the control device for controlling opening and closing of a window in accordance with the present invention is mounted on a window;

FIG. 5A is an illustrative view in accordance with the present invention of showing that the supporting member is positioned in the bracket;

FIG. 5B is an illustrative view in accordance with the present invention of showing that the supporting member moves relative to the bracket;

FIG. 6A is an illustrative view in accordance with the present invention of showing that the supporting member is pushed upward by the elastic piece;

FIG. 6B is an illustrative view in accordance with the present invention of showing that the supporting member moves downward to compress the elastic piece;

FIG. 7 is a perspective view in accordance with the present invention of showing that the motor is driving the supporting member to move horizontally by rotating the gear wheel of the gear reduction mechanism;

FIG. 8 is an exploded view of a gear reduction mechanism in accordance with another embodiment of the present invention; and

FIG. 9 is an illustrative view in accordance with another embodiment of the present invention of showing that the gear reduction mechanism is being driven by a motor.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

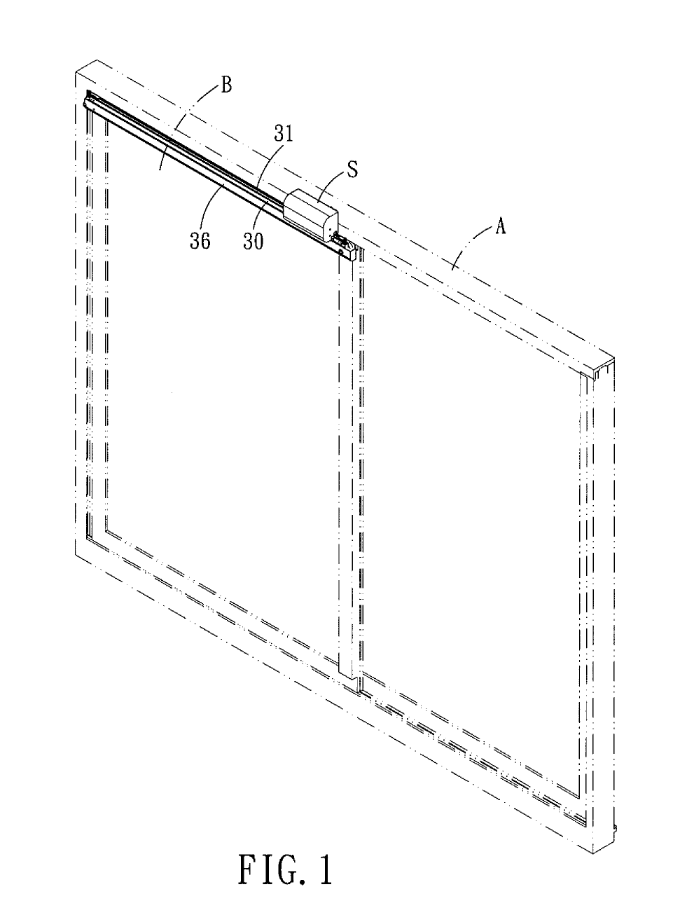

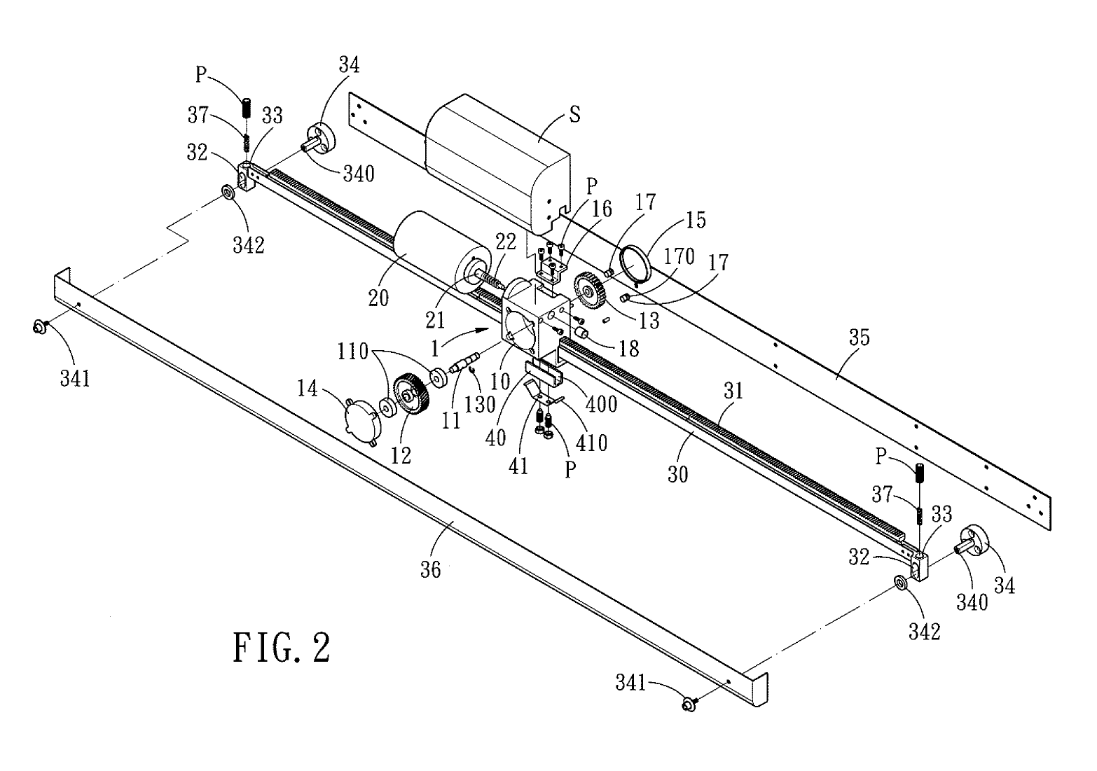

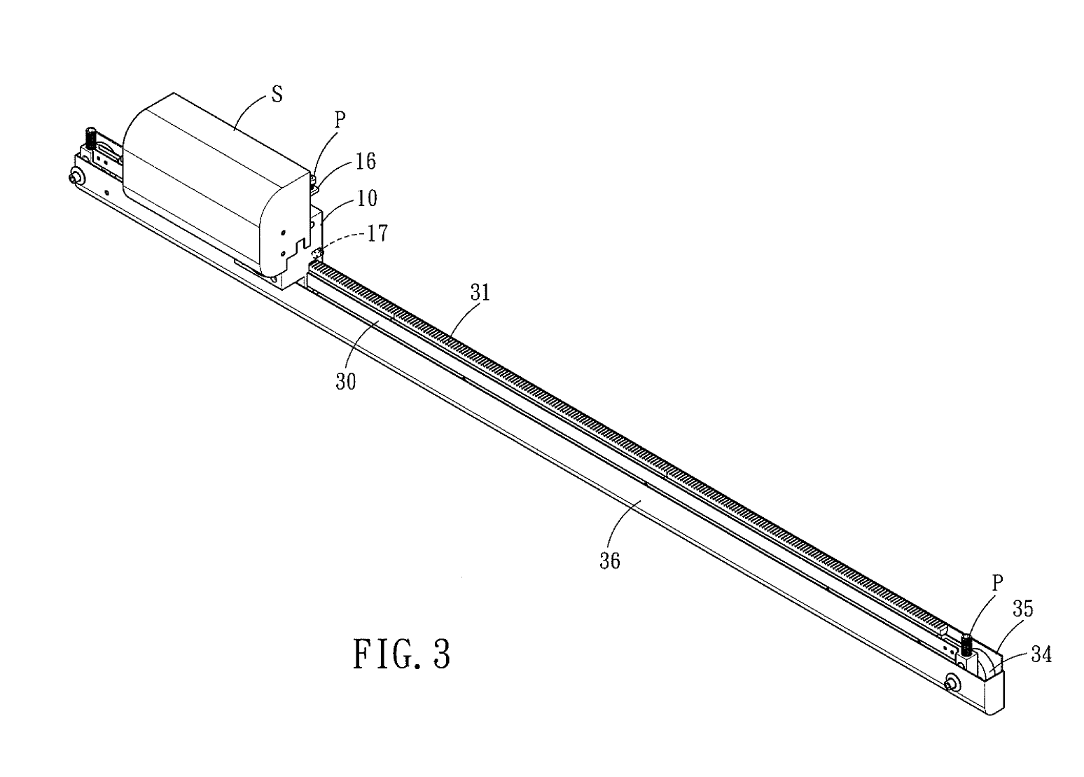

Referring to FIGS. 1-3, a control device for controlling opening and closing of a window in accordance with the present invention comprises: a gear reduction mechanism 1, a fixing block 16, a motor 20, and a supporting member 30.

The gear reduction mechanism 1 includes a box 10 which is defined with a space for installation of the subassembly of the reduction transmission mechanism. The subassembly of the reduction transmission mechanism is pivotally disposed in the box 10 by a shaft 11 and two bearings 110. The two bearings 110 are located at an end of the shaft 11, and between the two bearings 110 is arranged a worm wheel 12. A gear wheel 13 is disposed at the other end of the shaft 11 and is positioned thereto by a snap spring 130, so that the worm wheel 12 and the gear wheel 13 can rotate along with the shaft 11. The front and rear ends of the box 10 are sealed with a front cover 14 and a rear cover 15, respectively. The subassembly of the reduction transmission mechanism is positioned in place in the box 10.

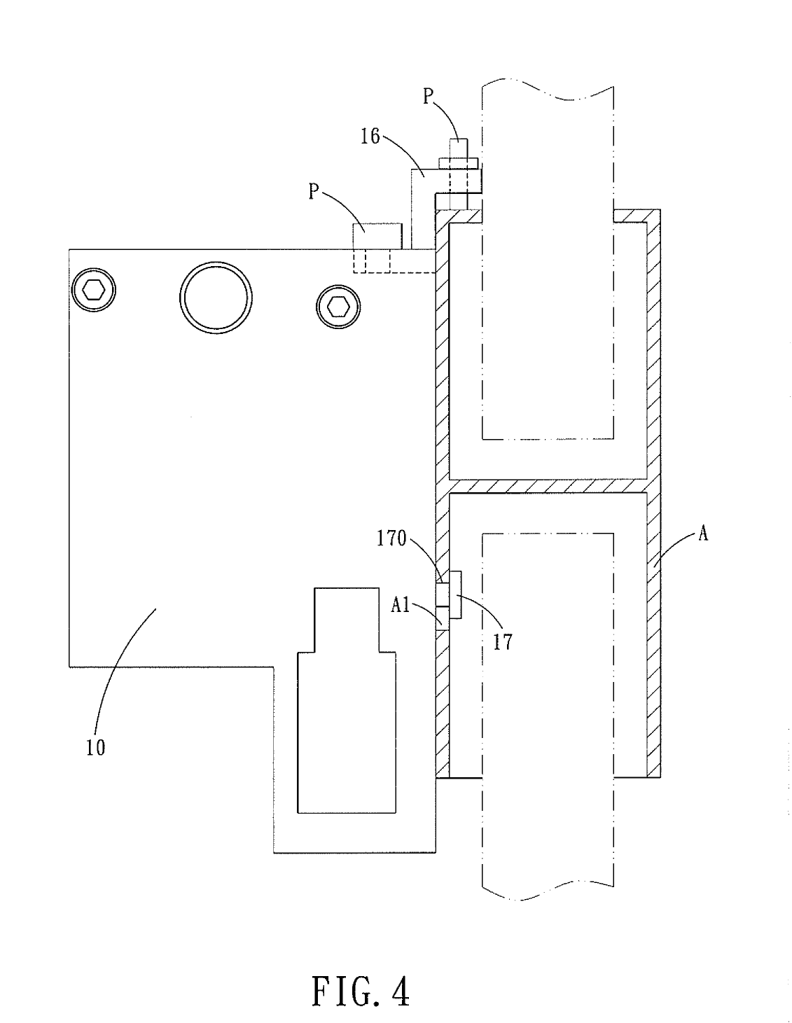

The fixing block 16 is a step-shaped structure with one end fixed to the rear of the top surface of the box 10 by screws P and with the other end fixed to the top edge of the window frame A by other screws P. Two positioning pins 17 are parallelly fixed to the lower portion of the rear surface of the box 10, and in each of the positioning pins 17 is defined an annular groove 170. As shown in FIG. 4, two through holes A1 are formed in the window frame A and are located correspondingly to the two positioning pins 17, and the diameter of the through holes A1 is larger than that of the positioning pins 17, so that the positioning pins 17 can be inserted therein. The width of the annular grooves 170 is almost equal to the thickness of the window frame A, such a design allows the box 10 to be positioned against a side of the window frame A in such a manner that the screws P abutted against the top edge of the box 10 serve to adjust the displacement of the box 10, and the annular groove 170 of the respective positioning pins 17 is engaged with the frame A at the position of the through holes A1. Therefore, the box 10 is positioned firmly.

The motor 20 is mounted on the box 10, and the transmission shaft of the motor 20 can be a worm 22 (or can be connected with a worm sleeve) to be disposed in the box 10 of the gear reduction mechanism 1 and engaged with the worm wheel 12. On the box 10 is further disposed a supporting member 18 on which the end of the transmission shaft 21 is pivotally positioned. By such arrangements, the transmission shaft 21 rotates the worm wheel 12 and the gear wheel 13 to carry out speed reduction transmission. The motor 20 and the box 10 are covered with a housing S that can be mounted on the box 10.

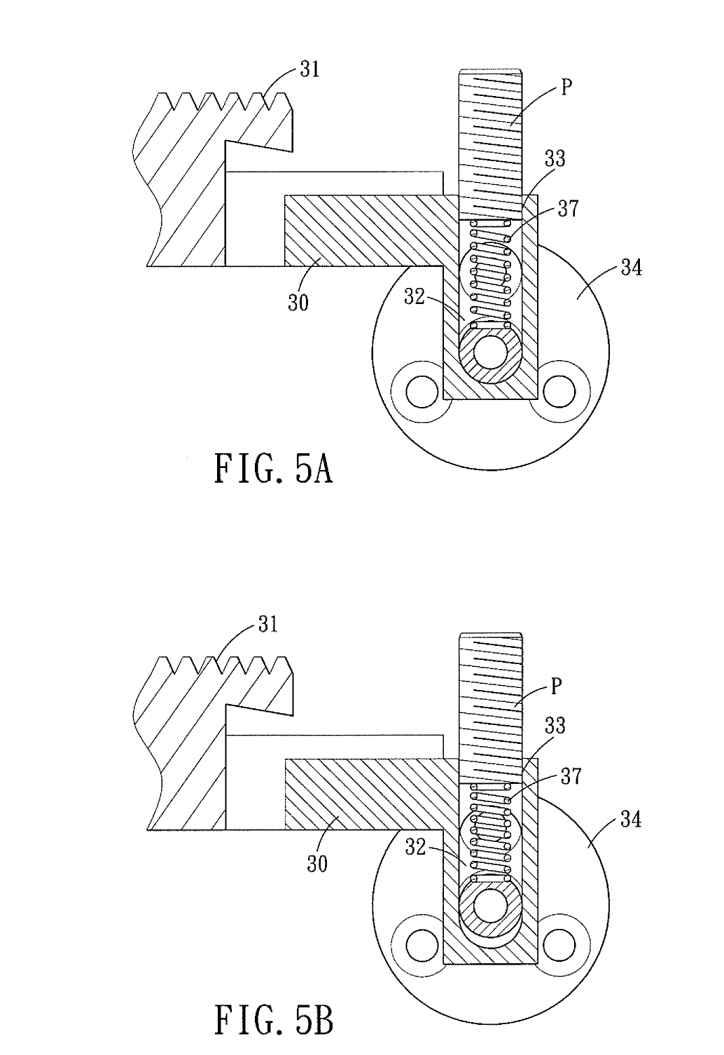

A supporting member 30 is inserted through the box 10 of the gear reduction mechanism 1 and is located at the lower portion thereof. On the top of the supporting member 30 is mounted a rack 31 for meshing with the gear wheel 13. Both ends of the supporting member 30 extend downward to form a reverse U shape, in each end thereof is formed a horizontal through slot 32, and above the through slot 32 is defined a vertical through hole 33. The supporting member 30 can be mounted on the window B through the cooperation of a plurality of mounting members. The mounting members include two brackets 34 to be inserted in the through slots 32 at both ends of the supporting member 30, and the rear end of the respective brackets 34 is fixed on a fixing plate 35 that can be fixed to the window B. Formed in the front end of the respective brackets 34 is a threaded hole 340, so that the front end of the brackets 34 can be mounted to a shell 36 through the cooperation of a screw 341, and a washer 342. By such arrangements, the supporting member 30 is positioned between the fixing plate 35 and the shell 36 by the two brackets 34, and then they are fixed to the window B together. In each of the through holes 33 is disposed a spring 37, and then a screw P is threaded in through hole 33 in such a manner that one end of the spring 37 is pressed against the bracket 34 and the other end thereof is confined within the through hole 33 by the screw P. By such arrangements, the elasticity of the spring 37 enables the supporting member 30 to move up and down relative to the brackets 34 (as shown in FIGS. 5A and 5B).

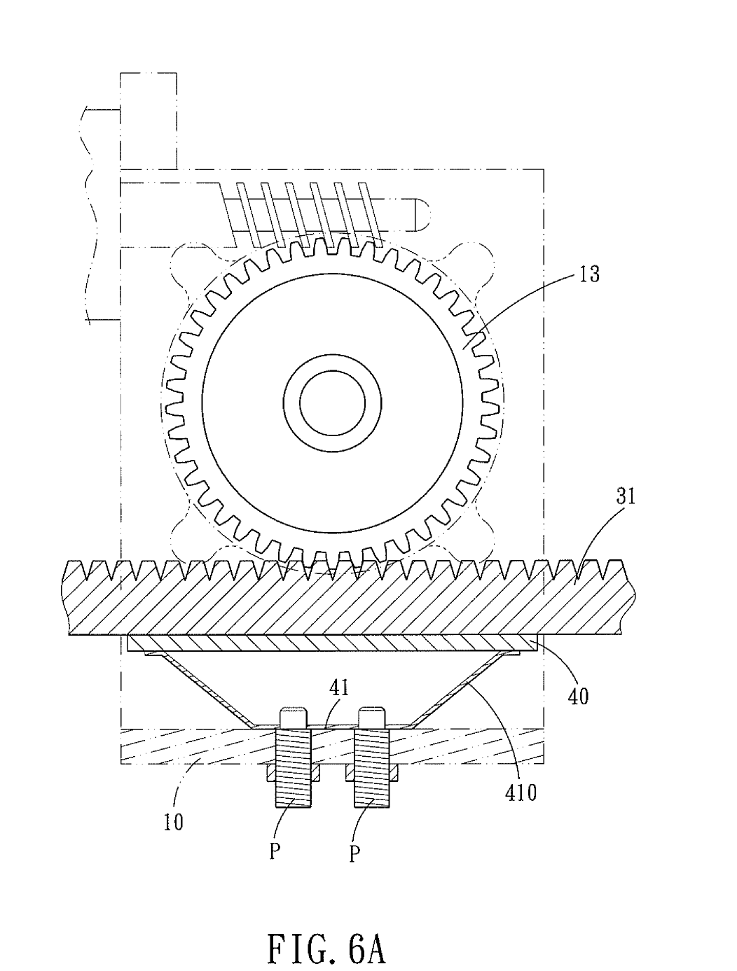

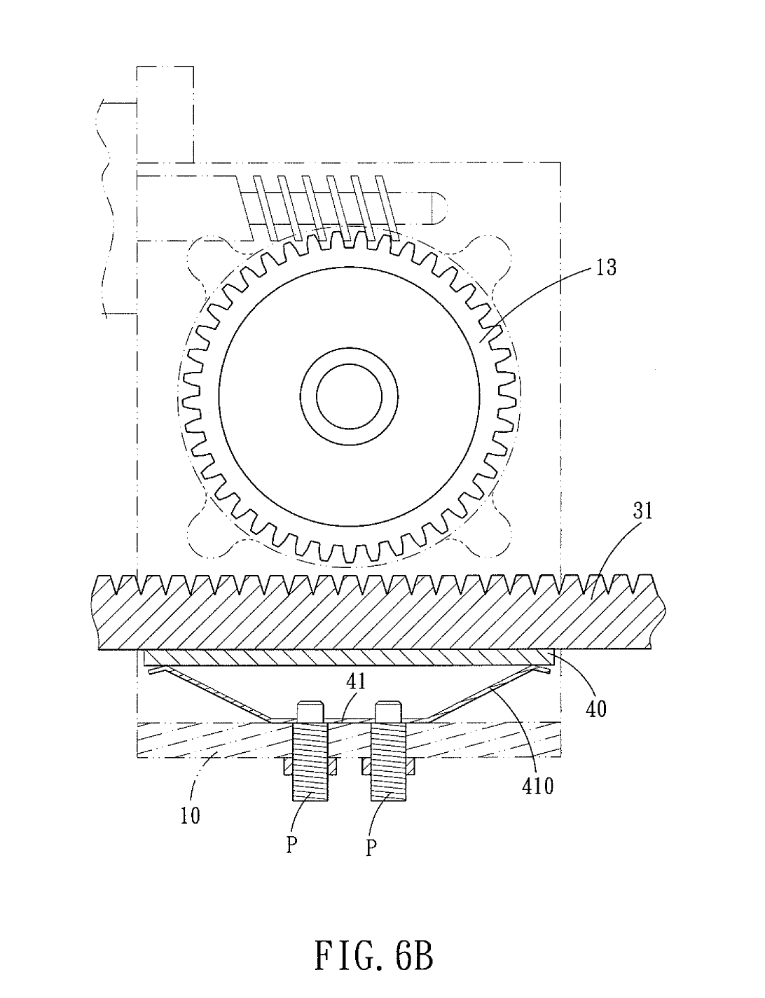

Referring to FIG. 6A, to prevent the window from being damaged by hindrances or any other problem during the course of opening and closing, a safety device is arranged below the supporting member 30. The safety device includes a U-shaped frame 40 with a U-shaped groove 400 for accommodation of the supporting member 30, an elastic piece 41 and a plurality of screws P. The elastic wings 410 at the top of the elastic piece 41 are pushed against the bottom of the U-shaped frame 40. The plurality of screws P is inserted from outside through the bottom of the box 10 in such a manner that the top end of the respective screws P is inserted in and pushed against the bottom of the elastic piece 41, and thus the elastic piece 41 is well positioned and supported. By such a design, the supporting member 30 and the U-shaped frame 40 can be positioned well by the upward pushing force of the wings 410 of the elastic piece 41, or can move downward when subjected to a downward force, so that the rack 31 and the gear wheel 13 can be engaged with or disengaged from each other, thus providing a safety function.

The aforementioned safety device can utilize the depth of the screws P threaded in the box 10 to adjust the position of the elastic piece 41, and the elastic piece 41 pushes against the U-shaped frame 40 and the supporting member 30, enabling the rack 31 to be engaged with the gear wheel 13 more closely (as illustrated in FIG. 6A). However, if there is a problem in opening or closing the windows (for example, there is a hindrance on the rail along which the window moves, or the slide wheel of the window is jammed, or something is jammed in rack), the elastic piece 41 will cooperate with the springs 37 at both ends of the supporting member 30 to allow the supporting member 30 to move downward (as shown in FIG. 6B), and consequently the rack 31 can be disengaged from the gear wheel 13, thus preventing the device of the present invention from being damaged in an unusual condition.

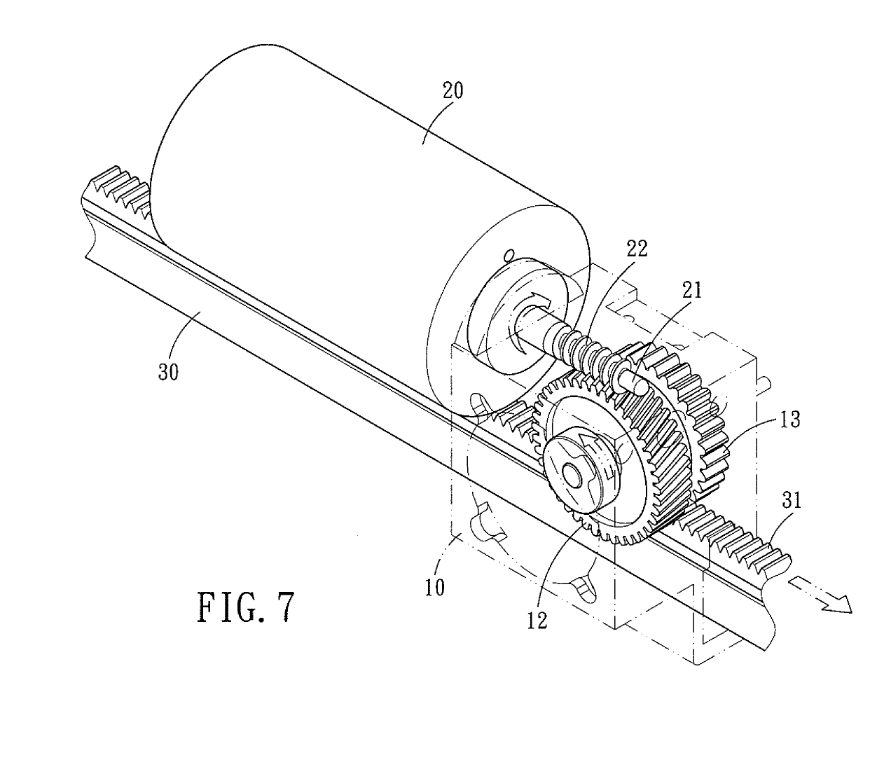

Referring to FIG. 7, when the present invention is in use, the motor 20 uses the worm 22 to drive the worm wheel 12 of the gear reduction mechanism 1, and coaxially rotate the gear wheel 13, thus driving the rack 31 and the supporting member 30 to move, and synchronously driving the window B to move transversely within the window frame A. In this way, the window can be opened and closed automatically.

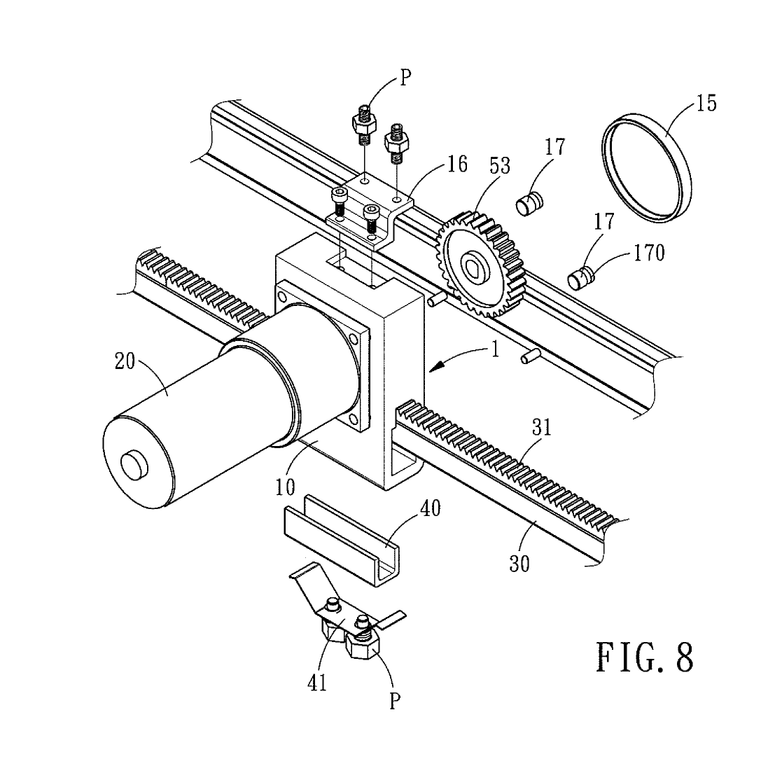

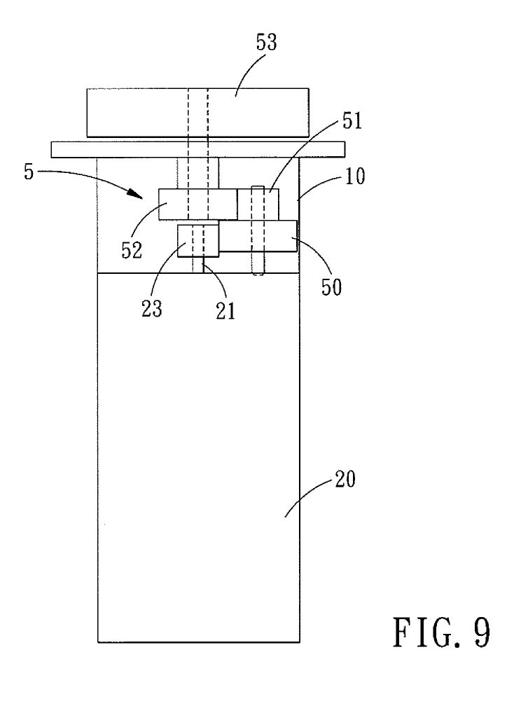

Referring to FIGS. 8 and 9, which show another embodiment of the present invention, the transmission shaft 21 of the motor 20 in this embodiment is provided with a first small gear wheel 23, the box 10 of the gear reduction mechanism 1 is interiorly defined with a space for accommodation of the subassembly of the reduction mechanism. The subassembly of the gear reduction mechanism can be an axially arranged compound gear set 5. At one end of the compound gear set 5 is disposed a first large gear wheel 50 to be engaged with the small gear wheel 23 of the motor 20. At one side of the large gear wheel 50 is coaxially arranged with a second small gear wheel 51 to be engaged with another noncoaxial second large gear wheel 52. At one side of the second large gear wheel 52 is arranged a gear wheel 53 for engaging with the rack 31. The motor 20 drives the rack 31 to move by rotating the compound gear set 5 of the gear reduction mechanism 1, thus obtaining the effect of automatically controlling the opening and closing of the door. The gear reduction mechanism generally provides a function of speed reduction and transmission. Besides the aforementioned compound gear set, the subassembly of the gear reduction mechanism of the present invention can also be a planetary gear set or any other assemblies. Since the gear reduction mechanism is not the major characteristic of the present invention, so further descriptions will be omitted here. And it is to be noted that any other replacement reduction mechanisms would be considered within the scope of the present invention.

The switch of the motor is connected to various control systems (such as fire fighting system, fire detection system, rain sensor, and etc), and the control system is set to send the signal to the device of the present invention and start the motor, thus achieving the purpose of automatically opening and closing the window. This design can open and close the window at a fixed time without manual effort. With connection to the rain sensor, the motor of the present invention can be switched on to close the window when it rains. With connection to the fire fighting system, in case of fire, the window can be opened automatically for facilitating ventilation or for emergency exit. With connection to the Co detecting system, in case of gas leakage, the window can be opened automatically for dissipation of the Co.

While we have shown and described various embodiments in accordance with the present invention, it is clear to those skilled in the art that further embodiments may be made without departing from the scope of the present invention.

What is claimed is:

1. A control device for controlling opening and closing of a window comprising:
a gear reduction mechanism having a box defined with a space for accommodation of subassembly of the gear reduction mechanism, the subassembly of the gear reduction mechanism including at least one gear wheel;
a motor being disposed at a side of the box of the gear reduction mechanism and serving to drive the subassembly of the gear reduction mechanism by using a transmission shaft, thus enabling the gear wheel to rotate at a lower speed;
a supporting member, on a top of which being disposed a rack to be engaged with the gear wheel of the gear wheel of the subassembly of the gear reduction mechanism, the supporting member being further provided with a plurality of mounting members for mounting the supporting member on a window;
the motor drives the subassembly and the gear of the gear reduction mechanism, and then the gear drives the supporting member and the rack to move, thus moving the window transversely.

2. The control device for controlling opening and closing of a window as claimed in claim 1, wherein the subassembly of the reduction transmission mechanism is pivotally disposed in the box by a shaft and two bearings, the two bearings are located at one end of the shaft, and between the two bearings is arranged a worm wheel, a gear wheel is disposed at the other end of the shaft and is positioned thereto by a snap spring, so that the worm wheel and the gear wheel rotate along with the shaft, a front end and a rear end of the box are sealed with a front cover and a rear cover, respectively, so that the subassembly of the reduction transmission mechanism is positioned in the box.

3. The control device for controlling opening and closing of a window as claimed in claim 1, wherein a fixing block has one end fixed to the rear of a top surface of the box and has the other end fixed to a top edge of a window frame by screws, two positioning pins are fixed to a lower portion of a rear surface of the box, and in each of the positioning pins is defined an annular groove, two through holes are formed in the window frame for insertion of the two positioning pins, the width of the annular grooves is almost equal to the thickness of the window frame, so that the annular grooves of the respective positioning pins are engaged with the frame at the position of the through holes, with the fixing block and the positioning pins, the box is positioned firmly against the window frame.

4. The control device for controlling opening and closing of a window as claimed in claim 1, wherein the motor is disposed on a side of the box, the transmission shaft is a worm to be engaged with the gear wheel of the subassembly of the gear reduction mechanism, so that the transmission shaft rotates the worm wheel and the gear wheel to carry out speed reduction transmission.

5. The control device for controlling opening and closing of a window as claimed in claim 1, wherein the motor and the box are covered with a housing that is to be mounted on the box.

6. The control device for controlling opening and closing of a window as claimed in claim 2, wherein the motor and the box are covered with a housing that is to be mounted on the box.

7. The control device for controlling opening and closing of a window as claimed in claim 4, wherein the motor and the box are covered with a housing that is to be mounted on the box.

8. The control device for controlling opening and closing of a window as claimed in claim 1, wherein the supporting member is inserted through the box of the gear reduction mechanism and is located at a lower portion thereof, both ends of the supporting member extend downward to form a reverse U shape, in each end of the supporting member is formed a horizontal through slot, and above the through slot is defined a vertical through hole.

9. The control device for controlling opening and closing of a window as claimed in claim 1, wherein the supporting member is mounted on the window by a plurality of mounting members, the mounting members include two brackets to be inserted in the through slots at both ends of the supporting member, and a rear end of the respective brackets is fixed on a fixing plate that is fixed to the window, formed in a front end of the respective brackets is a threaded hole through which the front end of the brackets is mounted to a shell through the cooperation of a screw, and a washer, by such arrangements, the supporting member is positioned between the fixing plate and the shell by the two brackets, and then they are fixed to the window together;
in each of the through holes is disposed a spring, and then a screw is threaded in through hole in such a manner that one end of the spring is pressed against the bracket and the other end of the spring is confined within the through hole by the screw, by such arrangements, the elasticity of the spring allows the supporting member to move up and down relative to the brackets.

10. The control device for controlling opening and closing of a window as claimed in claim 8, wherein the supporting member is mounted on the window by a plurality of mounting members, the mounting members include two brackets to be inserted in the through slots at both ends of the supporting member, and a rear end of the respective brackets is fixed on a fixing plate that is fixed to the window, formed in a front end of the respective brackets is a threaded hole through which the front end of the brackets is mounted to a shell through the cooperation of a screw, and a washer, by such arrangements, the supporting member is positioned between the fixing plate and the shell by the two brackets, and then they are fixed to the window together;
in each of the through holes is disposed a spring, and then a screw is threaded in through hole in such a manner that one end of the spring is pressed against the bracket and the other end of the spring is confined within the through hole by the screw, by such arrangements, the elasticity of the spring allows the supporting member to move up and down relative to the brackets.

11. The control device for controlling opening and closing of a window as claimed in claim 1, wherein a safety device is arranged below the supporting member, and the safety device includes a U-shaped frame with a U-shaped groove for accommodation of the supporting member, an elastic piece and a plurality of screws, two elastic wings at a top of the elastic piece are pushed against a bottom of the U-shaped frame, a plurality of screws is inserted through the bottom of the box in such a manner that a top end of the respective screws is inserted in and pushed against a bottom of the elastic piece to position and support the elastic piece, by such arrangements, the supporting member and the U-shaped frame utilizes an upward pushing force of the wings of the elastic piece to make the rack disengage from the gear wheel of the gear reduction mechanism, when subjected to a downward force, the supporting member will move downward to make the rack engage with the gear wheel of the gear reduction mechanism.

12. The control device for controlling opening and closing of a window as claimed in claim 1, wherein the transmission shaft of the motor is provided with a first small gear wheel, the subassembly of the gear reduction mechanism is an axially arranged compound gear set, at one end of the compound gear set is disposed a first large gear wheel to be engaged with the first small gear wheel of the motor, at one side of the large gear wheel is coaxially arranged with a second small gear wheel to be engaged with a noncoaxial second large gear wheel, at one side of the large gear wheel is coaxially arranged a gear wheel for engaging with the rack, the motor drives the rack to move by rotating the compound gear set of the gear reduction mechanism, thus obtaining the effect of automatically controlling the opening and closing of the door.
